(19) United States
(12) Patent Application Publication
(10) Pub. No.: US 2012/0117305 A1
(43) Pub. Date: May 10, 2012

(54) Method Of Storing Blocks Of Data In A Plurality Of Memory Devices For High Speed Sequential Read, A Memory Controller And A Memory System

(75) Inventor: Siamak Arya, Cupertino, CA (US)

(73) Assignee: Greenliant LLC

(21) Appl. No.: 12/941,912

(22) Filed: Nov. 8, 2010

(51) Int. Cl. G06F 12/06; G06F 12/00

(52) U.S. Cl. 711/103; 711/170; 711/E12.078; 711/E12.008

(57) ABSTRACT

A method for controlling the storage of a plurality of blocks of sequential data in a plurality of independent NAND memory devices, where each NAND memory device can be independently written to or read from in a block of data, with the block as the minimum unit of storage to be written to or read from. The method includes assigning a different NAND memory device to each different block of data received for storage and for storing the plurality of blocks of data in the plurality of different NAND memory devices. Efficiency of readout of sequential blocks of data is improved. The present invention also comprises a memory controller having a processor and a non-volatile memory for storing programming code that can perform the foregoing method. Finally, the present invention is a memory system that has a plurality of NAND memory devices device that can be independently written to or read from in a block of data, with the block as the minimum unit of storage to be written to or read from. The memory system further has a memory controller that has a processor and non-volatile memory for storing programming code that can be executed by the processor in accordance with the foregoing described method.

### TECHNICAL FIELD

The present invention relates to a method for storing efficiently a plurality of blocks of data among a plurality of independently read/writable non-volatile memory devices that have a block of data as the minimum amount of data that can be read from or written to the memory device. The plurality of blocks of data are received randomly in time. The method stores the plurality of blocks of data so that upon subsequent sequential readout of the blocks of data from the plurality of non-volatile memory devices, read efficiency is increased. The present invention also relates to a memory controller that executes the foregoing described method as well as a memory system with a memory controller that executes the method.

### BACKGROUND OF THE INVENTION

Non-volatile memory devices that store or read a block of data at a time, such as a page of data, are well known in the art. For example, NAND memory devices typically can store a page, such as 4 kilobytes, of data in the device at each read/write operation. Other types of non-volatile memory devices that store or read a block of data at a time, include so called managed NAND memory devices, such as the NANDrive (NANDrive is a trademark of Greenliant Systems, Inc.) memory device available from Greenliant Systems, Inc. of Santa Clara Calif. In a managed NAND memory device, such as the NANDrive memory device, a controller controls the raw (or unmanaged) NAND memory device so that standard interface, such as SATA (serial ATA) or PATA (parallel ATA) can be used to interface with the NANDrive memory device. As used herein, the term “NAND memory device” shall refer to both raw as well as managed NAND memory devices.

In a NAND memory device, the non-volatile memory device can be written to or read from only in blocks of data at a time. Because of their ability to read back a block of data at a time, NAND memory devices are useful to store large amounts of data.

In the prior art, many NAND memory devices are clustered to form a large storage system, to compete with the magnetic or optical storage medium to store a large amount of data. In such application, many NAND memory devices are used, with each NAND memory device being independently controllable to read from or to write to. Each NAND memory device is an integrated circuit chip (or in the case of NANDrive, a memory module with a NAND memory controller and a raw NAND memory chip) and includes a buffer for storing a block of data to be written to or read from the non-volatile memory cells in the memory array. As with the magnetic storage medium with which it replaces, each NAND memory device stores and retrieves blocks of data based upon a physical address for each block. Further, to the outside world, each block of data to be written into or read from has a logical address. All of this is well known to one of ordinary skill in the art. Therefore, memory controller operating the NAND memory device(s) must have an address mapping table mapping the logical address of the block of data with the physical address of where the data is stored.

Referring to FIG. 1 there is shown a schematic block diagram of a memory system 10 of the prior art and the method of storing a plurality of blocks of data and the problem of subsequent read of sequential blocks. By read of sequential blocks, it is meant the reading of blocks of data having sequential logical addresses. FIG. 1 shows eight (8) sequential blocks of data, having logical addresses of “logical address 1”, “logical address 2”, “logical address 3” etc. The memory system 10 also has 4 NAND memory devices 20(a-d), shown as “Device 1”, “Device 2”, “Device 3” and “Device 4”, respectively. A memory controller (not shown) controls the operation of the Devices 20(a-d) as well as the directing of the blocks of data into the various Devices 20(a-d). In the prior art, when the blocks of data are received, the memory controller assigns each block of data to be stored randomly into one of the plurality of Devices 20(a-d). Thus, by way of example, the block of data having logical address 1 is assigned to be stored at the physical address A in Device 20a. The block of data is then transferred into the buffer within the Device 20a. While the Device 20a is operating to store or program the data from its buffer into the non-volatile memory cells, the memory controller can then transfer the next received block of data having logical address 4 to be stored at the physical address D in Device 20c. The block of data having the logical address 4 is stored in the buffer of the Device 20c, for the Device 20c to operate on the non-volatile memory cells to program them to store the data from its buffer. Similarly, the memory controller can randomly assign the next received block of data having the logical address 2 to be stored in memory Device 20a. The memory controller of the prior art selectively stores the received blocks of data randomly based upon factors such as wear level, i.e. to even the wear among all the NAND memory devices 20(a-d) or capacity or other factors.

The problem with the storage of these blocks of data that are received randomly in time is that when it is desired to perform a read of sequential blocks of data from the system 10, there may be a bottleneck in the sequential read-out of the plurality of blocks of data. For example, during the sequential read out, Devices 20a and 20b (and in fact all of the devices) can be “turned on” to cause the read-out of the blocks of data from the non-volatile memory cells into the associated buffer. However, if the blocks of data having different logical addresses are stored in the same physical memory device 20, then the memory device 20 can be used to read only one block of data. Thus, until the device 20a finishes the read of the block of data having the logical address 1, device 20a cannot be used to read any other blocks of data. The reading of the block of data having logical address 2 has to wait until the read out of data from memory device 20a is completed. So long as Device 20a is still servicing the read out of the block of data associated with logical address 1, the block of data associated with logical address 2 cannot even begin to be processed, since the block of data from the non-volatile memory cells in the Device 20a are still stored in the buffer within the device 20a. Hence, in the prior art, such a bottleneck can cause a decrease in the read performance of sequential blocks of data.

### SUMMARY OF THE INVENTION

Accordingly, in the present invention, a method of storing a plurality of blocks of data received, in a plurality of physically distinct memory devices with each memory device capable of being independently written to or read from. Each block of data received is the minimum amount of data that can be written to or read from the memory device and each block has an associated logical address, with the plurality of blocks of data received collectively having a logical address range. The method comprises assigning a different memory device to each different block of data received for storage based on the associated logical address of the received data block. The logical address range of the plurality of blocks of data is interleaved among the plurality of physically distinct memory devices. The plurality of blocks of data received are then stored in the plurality of distinct physical memory devices.

The present also relates to a memory controller for controlling a plurality of independent memory devices. The memory controller has a processor and a non-volatile memory for storing programming code for execution by the processor in accordance with the foregoing described method.

Finally, the present invention relates to a memory system having a plurality of independent memory devices and the foregoing described memory controller for controlling the plurality of memory devices.

### BRIEF DESCRIPTION OF THE DRAWINGS

FIG. 1 is a block level diagram of a memory system operated in accordance with the method of the prior art.

FIG. 2 is a schematic block diagram of a memory controller and a memory system for operating the method of the present invention.

FIG. 3 is a block level diagram of a memory system operated in accordance with the method of the present invention.

FIG. 4 is a diagram of a mapping table for implementing the preferred embodiment of the method of the present invention.

### DETAILED DESCRIPTION OF THE INVENTION

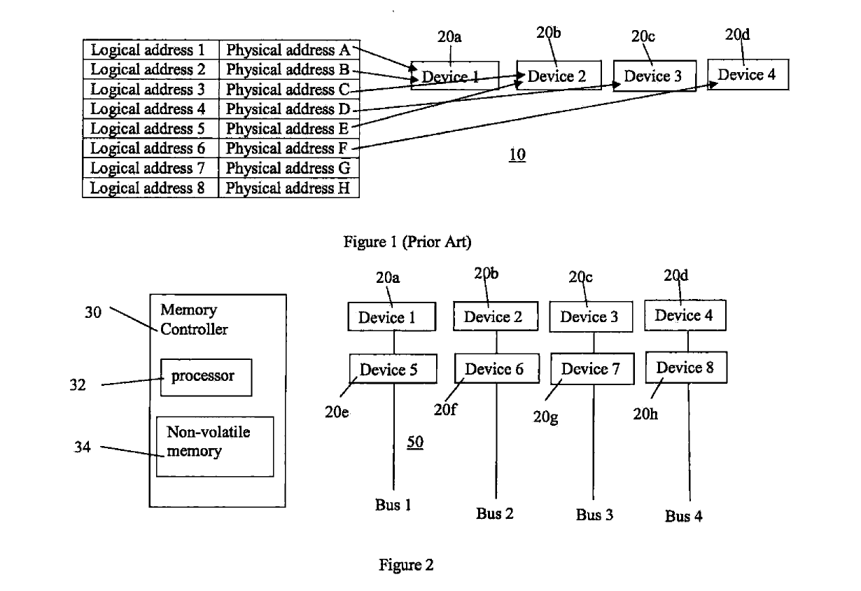

Referring to FIG. 2 there is shown a memory system 50 of the present invention. In the memory system 50 of the present invention, a memory controller 30 controls a plurality of NAND memory devices 20(a-h), each of which can be the same as the NAND memory devices 20 of the prior art shown in FIG. 1. The NAND memory devices 20(a-h) in the preferred embodiment are arranged in an array, with a plurality of rows and columns. Each of the NAND memory devices 20 in the same column is connected to the same bus. Thus, in the embodiment shown in FIG. 2, the NAND memory devices 20(a-h) are arranged in two rows and four columns, with four buses (“Bus 1”, “Bus 2”, “Bus 3”, and “Bus 4”) as the output buses of the system 50.

The memory controller 30 comprises a processor 32 and a non-volatile memory 34, typically NOR memory, for storing programming code to be executed by the processor 32. The programming code stored in the NOR memory 34 causes the processor 32 to operate the method of the present invention in controlling the storage of a plurality of blocks of sequential data to be stored in the plurality of NAND memory devices 20(a-h).

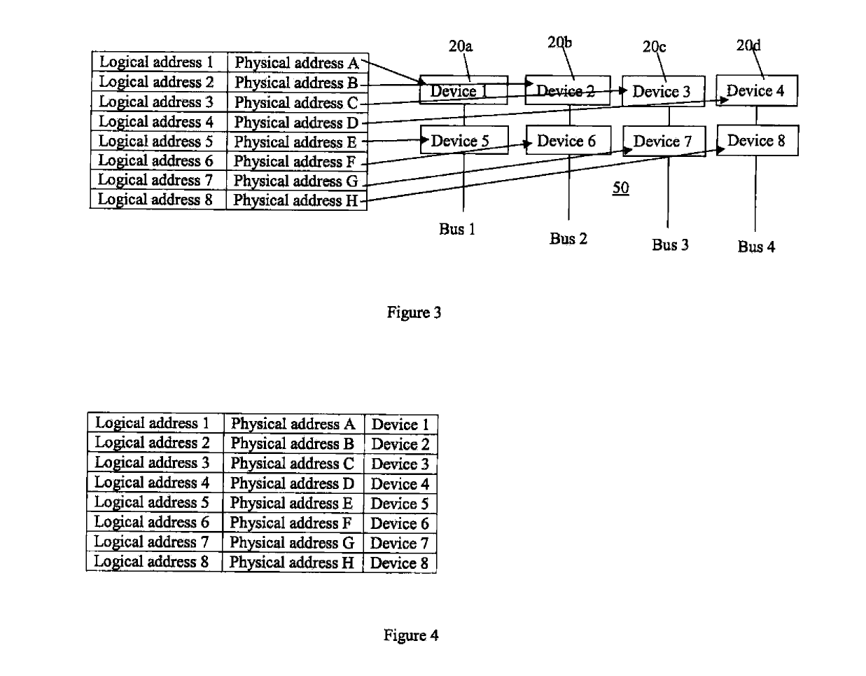

Referring to FIG. 3 there is shown a block level diagram of the memory system 50 operated in accordance with the method of the present invention. Similar to the diagram shown in FIG. 1, the system 50 receives a plurality of blocks of data. The plurality of blocks of data are received randomly in time. Thus, the logical address of the plurality of blocks of data do not necessarily have any particular order. Similar to the description for the example shown in FIG. 1, the memory system 50 of the present invention receives a plurality of blocks of data having logical addresses of 1, 2, 3, although the memory system 50 may not necessarily received the blocks of data in that order. Each Logical Address x is assigned to a physical address such that the block of data associated with the logical address is subsequently stored in a physical memory device 20(a-h) different from the other physical memory devices 20(a-h), such that collectively the logical addresses of the plurality of received blocks of data are spread over all the memory devices 20(a-h). Thus, the block of data having the logical address 1 is associated with a physical device address A which is stored in Device 20a. The block of data having the logical address 2 is associated with a physical device address B which is stored in Device 20b. The block of data having the logical address 3 is associated with a physical device address C which is stored in Device 20c. This process of assigning the logical address to a physical address of a different device, continues until either all of the logical addresses of blocks of sequential data have been assigned or until all of the physical devices 20(a-h) are used. In this manner, the collective logical addresses of all the received plurality of blocks of data is distributed among all of the memory devices 20(a-h). Furthermore, the distribution is by “interleaving”, i.e. with no overlapping of logical addresses of data in the same physical memory device 20.

The advantage of the method of the present invention is as follows. For a readout of the eight blocks of sequential data associated with logical addresses of Logical Address 1, 2, . . . and 8, all eight memory devices 20(a-h) can be activated to read the contents of the memory cells from their respective arrays in their physical addresses of A, B, . . . and H at the same time, and store them in the buffer of the associated memory devices 20(a-h). Thereafter, the data can be read from the buffers of the memory devices 20(a-h) in the order of 20a, 20b, . . . and 20h, by supplying data from the buffer of the memory device 20 onto the bus, 1 . . . 4. If the buses: Bus 1 . . . Bus 4 can be operated in parallel, then all four blocks of data can be outputted from the system 50 at the same time. If the buses: Bus 1. Bus 4 cannot be operated in parallel, then each block of data having the logical address of Logical Address 1 . . . 4 is transferred to the buses: Bus 1 . . . Bus 4, in sequence. Once a block of data, e.g. block of data from device 20a is transferred to Bus 1, the Bus 1 is available again, and the block of data in the buffer of memory device 20e can be transferred onto Bus 1, while the data from the other memory devices (b-d) is being transferred from the other buses. Alternatively, if the buses Bus 1 . . . . Bus 4 can be operated in parallel, then once all four blocks of data have been outputted, the data stored in the buffer of the memory devices 20(e-h) can be transferred on to the buses, Bus 1, Bus 2, . . . Bus 4, to be outputted from the memory system 50. In this way, a faster readout of the blocks of sequential data can be obtained compared to the method of the prior art.

To ensure that the memory controller 30 assign the logical address of a block of data to the physical address of a memory device different from a memory device associated with a different block of data, the following preferred method can be used. It should be noted that although the following method is preferred, it is by no means the only method.

In the preferred method of the present invention, the memory controller 30 must first determine the number N of independently read/writable memory devices 20(a-h) that can be used to store the plurality of blocks of data arriving randomly in time. In the preferred method of the present invention, the memory controller 30 takes the logical address of a block of data and performs a modulo N operation, and note the remainder. The remainder is then assigned as the device ID and can be concatenated to the physical address. The operation would then consist of REM (MOD (Logical Address X),N). The remainder can have a value between 0 and N−1. If the remainder of the operation is M, where M is between 0 and N−1, the same operation performed on an immediate subsequent block of data would result in M+1. Thus, in the example shown in FIG. 3, the operation would result in a value between 0 and 7 representing a maximum of 8 memory devices 20. The value converted to a binary of 3 bits is the least significant bits of the logical address of the data block. i.e. the collective data blocks are stored interleaved across all the memory Devices 20(a-h). Then, the logical address of the data block minus these least significant 3 bits, with the data, is sent to the device represented by the least significant 3 bits. This logical address is then converted to the physical address of the corresponding device either in the device if control is distributed or by a central controller before sending to the device. That physical address would then uniquely determine the memory Device 20(a-h) with the physical address. As a result, no two blocks of data having consecutive logical addresses are stored in the same physical device 20. Referring to FIG. 4, there is shown the additional fields in the mapping table maintained by the memory controller 30 using the preferred method of the present invention.

When the blocks of data are stored in the foregoing manner, a sequential read operation will result in much faster speed. Because the reading of the data from the non-volatile memory cells into the buffers of the various memory devices 20(a-h) can be done in parallel for the sequential blocks of data, the total read out time required for the read out of the sequential blocks of data can be reduced.

What is claimed is:

1. A method of storing a plurality of blocks of data received, in a plurality of physically distinct memory devices, each being independently written to or read from, wherein each block of data received has an associated logical address and is the minimum amount of data that can be written to or read from the memory device, with said plurality of blocks of data received collectively having a logical address range, said method comprising:
assigning a different memory device to each different block of data received for storage based on the associated logical address of the received data block, wherein said logical address range is distributed among the plurality of physically distinct memory devices; and
storing said plurality of blocks of data received in said plurality of distinct physical memory devices.

2. The method of claim 1 wherein said assigning step assigns blocks of data having consecutive sequential logical addresses to different memory devices.

3. The method of claim 1 wherein said assigning step further comprises performing a modulo operation on the logical address associated with a block of data received by N, where N is the total number of physical memory devices; and assigning the remainder of said modulo operation, as the address of said physical memory device to said block of data.

4. A memory controller for controlling the storage of a plurality of blocks of sequential data in a plurality of physically distinct memory devices, each being independently written to or read from, wherein each block of data has an associated logical address and collectively the plurality of blocks of sequential data has a logical address range, with the block as the minimum amount of data that can be written to or read from the memory device, said memory controller comprising
a processor, and
a non-volatile memory storing programming code for execution by said processor, said programming code for assigning a different memory device to each different block of data received for storage based on the associated logical address of the received data block, wherein said logical address range is distributed among the plurality of physically distinct memory devices; and for storing said plurality of blocks of data received in said plurality of distinct physical memory devices.

5. The memory controller of claim 4 wherein said programming code for assigning assigns blocks of data having consecutive sequential logical addresses to different memory devices.

6. The memory controller of claim 4 wherein said programming code for assigning further comprises programming code for performing a modulo operation on the sequential logical address associated with a block of sequential data by N, where N is the total number of physical memory devices; and for assigning the remainder of said modulo operation, as the address of said physical memory device to said block of sequential data.

7. The memory controller of claim 4 wherein processor and said non-volatile memory are formed in an integrated circuit device.

8. A memory system comprising:
a plurality of memory devices, wherein each memory device being capable of being independently written to or read from in a block of data wherein said block of data is the minimum amount of data that can be written to or read from a memory device;
a controller for controlling the storage of a plurality of blocks of data received, wherein each block of data having a logical address associated therewith and collectively, the plurality of blocks having a logical address range associated therewith, said controller comprises:
a processor; and
a non-volatile memory storing programming code for execution by said processor, said programming code for assigning a different memory device to each different block of data received for storage based on the associated logical address of the received data block, wherein said logical address range is distributed among the plurality of physically distinct memory devices; and for storing said plurality of blocks of data received in said plurality of distinct physical memory devices.

9. The memory system of claim 8 wherein said programming code for assigning assigns blocks of data having consecutive sequential logical addresses to different memory devices.

10. The memory system of claim 8 wherein said programming code for assigning further comprises programming code for performing a modulo operation on the sequential logical address associated with a block of sequential data by N, where N is the total number of physical memory devices; and for assigning the remainder of said modulo operation, as the address of said physical memory device to said block of sequential data.

11. The memory system of claim 8 wherein processor and said non-volatile memory are formed in an integrated circuit device.

12. The memory system of claim 8 wherein said plurality of physically distinct memory devices are arranged in an array with a plurality of rows and columns.

13. The memory system of claim 12 wherein memory devices in the same column are connected to the same bus.

14. A method of operating a plurality of physically distinct memory devices, wherein each memory device can be independently written to or read from by a block of data with the block as the minimum amount of data that can be written to or read from the memory device, wherein each memory device having an array of non-volatile memory cells and a buffer, said method comprising:
writing a plurality of blocks of data received, in said plurality of physically distinct memory devices, wherein each block of data received having an associated logical address, with said plurality of blocks of data received collectively having a logical address range, said writing by:
assigning a different memory device to each different block of data received for storage based on the associated logical address of the received data block, wherein said logical address range is distributed among the plurality of physically distinct memory devices;
storing said plurality of blocks of data received in said plurality of distinct physical memory devices;
reading a plurality of blocks of data stored in said plurality of physically distinct memory devices, wherein said plurality of blocks of data read having sequential logical addresses; said reading by:
reading said plurality of physically distinct memory devices simultaneously by reading non-volatile memory cells associated with said sequential logical addresses and storing in the associated buffers; and
reading the associated buffers as output of said plurality of memory devices.

15. The method of claim 14 wherein said plurality of physically distinct memory devices are arranged in an array.

16. The method of claim 14 wherein said assigning step assigns blocks of data having consecutive sequential logical addresses to different memory devices.

17. The method of claim 14 wherein said assigning step further comprises performing a modulo operation on the logical address associated with a block of data received by N, where N is the total number of physical memory devices; and assigning the remainder of said modulo operation, as the address of said physical memory device to said block of data.
